(19) United States
(12) Patent Application Publication
(10) Pub. No.: US 2012/0143410 A1
(43) Pub. Date: Jun. 7, 2012

(54) INTERACTIVE DRIVER SYSTEM FOR AN ELECTRIC VEHICLE

(75) Inventors: Brian Lee Gallagher, Oceanside, CA (US); Richard Lewis Fabini, Cardiff-by-the Sea, CA (US); Kurt Gordon Jensen, Aurora, CO (US)

(73) Assignee: APTERA MOTORS, INC., Oceanside, CA (US)

(21) Appl. No.: 12/957,870

(22) Filed: Dec. 1, 2010

(51) Int. Cl. G06F 19/00

(52) U.S. Cl. 701/22

(57) ABSTRACT

An interactive driver system is provided that alleviates range anxiety for the driver of an electric vehicle. The system includes: a range monitor module that determines range of the electric vehicle and identifies a given condition of the vehicle in which the range of the vehicle may be exceeded during ongoing operation of the vehicle; a load monitor module that identifies one or more electric loads being placed on a battery of the electric vehicle; and a driver notification module that presents suggestions on a display of the vehicle to the driver of the vehicle for reducing energy consumption by the vehicle upon occurrence of the given condition, where the suggestions relate to the identified electric loads. The suggestions presented to the driver preferably identify an action to be taken by the driver that reduces energy consumption and an associated change in the range of the vehicle if the action is taken by the driver.

### FIELD

The present disclosure relates to an interactive system that will increase range confidence for the driver of an electric vehicle.

### BACKGROUND

Electric vehicles are becoming more prevalent in the marketplace. Electric vehicles typically use one or more electric motors powered by an energy storage system for propulsion. Over time, energy stored in the energy storage system is depleted and needs to be replenished. To recharge the battery system, the vehicle driver will need to find a suitable charging station.

Unlike fuel stations for vehicles driven by internal combustion engines, suitable charging stations for electric vehicles have not yet become commonplace. When driving an electric vehicle with a limited amount of energy, the vehicle driver may feel uneasy about reaching the destination (i.e., experience range anxiety). Therefore, it is desirable to implement a system and methods designed to alleviate range anxiety for drivers of electric vehicles. An interactive driver system should preferably keep the driver apprised of the vehicle range and present the driver with suggestions for reducing energy consumption and thereby increasing the range of the vehicle.

This section provides background information related to the present disclosure which is not necessarily prior art.

### SUMMARY

An interactive driver system is provided that increases range confidence for the driver of an electric vehicle. The system includes: a range monitor module that determines range of the electric vehicle and identifies a given condition of the vehicle in which the range of the vehicle may be exceeded during ongoing operation of the vehicle; a load monitor module that identifies one or more electric loads being placed on a battery of the electric vehicle; and a driver notification module that presents suggestions on a display of the vehicle to the driver of the vehicle for reducing energy consumption by the vehicle upon occurrence of the given condition, where the suggestions relate to the identified electric loads. The suggestions presented to the driver preferably identify an action to be taken by the driver that reduces energy consumption and an associated change in the range of the vehicle if the action is taken by the driver.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### DRAWINGS

FIG. 1 is a diagram of an exemplary interactive driver system that increases range confidence for the driver of an electric vehicle;

FIG. 2 is a diagram of an exemplary communication network that may be employed by the electric vehicle;

FIG. 3 is a diagram of an exemplary computing architecture for an infotainment subsystem;

FIG. 4 is a diagram detailing operation of the interactive driver subsystem;

FIG. 5 illustrates an exemplary user interface that queries the driver about changing desired destination;

FIG. 6 illustrates an exemplary user interface that presents suggestions for conserving energy to the vehicle driver;

FIG. 7 illustrates an exemplary map having indicia for the current vehicle range and how the range might change; and

FIG. 8 illustrates an exemplary user interface that queries the driver about finding a charging station.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

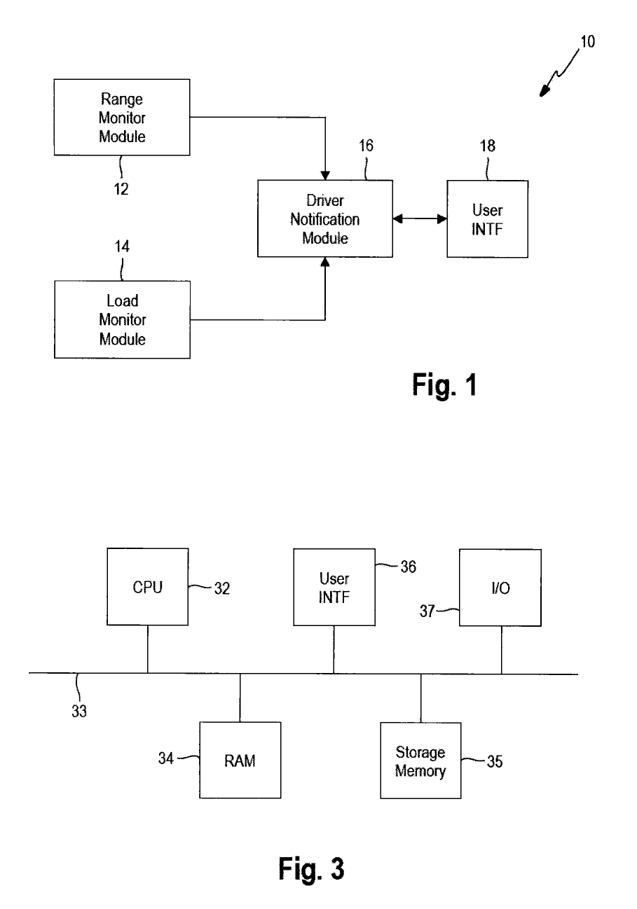

FIG. 1 depicts an exemplary interactive driver system 10 that increases range confidence for the driver of an electric vehicle, where the vehicle is powered exclusively or primarily by a battery. In a simplified embodiment, the interactive driver subsystem 10 will periodically compute the vehicle range and make this information available for query by the driver. The driver may opt to configure an instrument cluster and/or an infotainment system to continually display the vehicle range to the driver. The driver may also interact with the user interface device 18 to retrieve the vehicle range. While reference is made to an electric vehicle powered by a battery, it is envisioned that this disclosure is applicable to electric vehicles powered by other types of renewable power sources.

A more robust embodiment of the interactive driver subsystem 10 proactively keeps the driver apprised of the vehicle range and presents the driver with suggestions for reducing energy consumption. In this embodiment, the system 10 is comprised of a range monitor module 12, a load monitor module 14, a driver notification module 16 and a user interface device 18, such as a touchscreen accessible to the driver of the vehicle. As used herein, the term module may refer to, be part of, or include an electronic circuit; a combinational logic circuit; an application specific integrated circuit (ASIC); a field programmable gate array (FPGA); a computer processor that executes computer executable instructions; or other suitable components that provide the described functionality.

The range monitor module 12 determines the current range of the electric vehicle and identifies an occurrence of a condition in which the range of the vehicle may be exceeded by ongoing operation of the vehicle. For example, by determining a destination for the electric vehicle and comparing the distance to the destination with the current range of the vehicle, the range monitor module 12 can identify a condition in which the range of the vehicle may be exceeded. In another example, the range monitor module 12 monitors the state of charge of the battery and deems the vehicle in a condition in which the range may be exceeded when the state of charge is less than a predefined threshold. When such a condition occurs, the range monitor module 12 notifies the driver notification module 16 of the condition. Other types of conditions in which the vehicle range may be exceeded are also contemplated by this disclosure.

The driver notification module 16 presents suggestions for reducing energy consumption by the vehicle upon occurrence of such a condition. The suggestions will relate to one or more electric loads being placed on the battery of the vehicle. Thus, the load monitor module 14 functions to identify any electric loads being placed on the battery of the electric vehicle. Information about what loads are being placed on the battery and parameters related thereto (e.g., device power rating) can be acquired over the vehicle communication bus by the load monitor module and passed along to the driver notification module 16 for subsequent processing.

The drive notification module 16 presents suggestions for reducing energy consumption to the driver on a display of the vehicle. More specifically, the driver notification module 16 identifies an action to be taken by the driver that will reduce energy consumption. For instance, when HVAC is on, the driver may be advised to lower the fan speed of the HVAC. In this way, the suggestion relates to the electric loads being placed on the battery of the vehicle. The driver notification module 16 may also compute and display to the driver an associated change in the range of the vehicle if the action is taken by the driver.

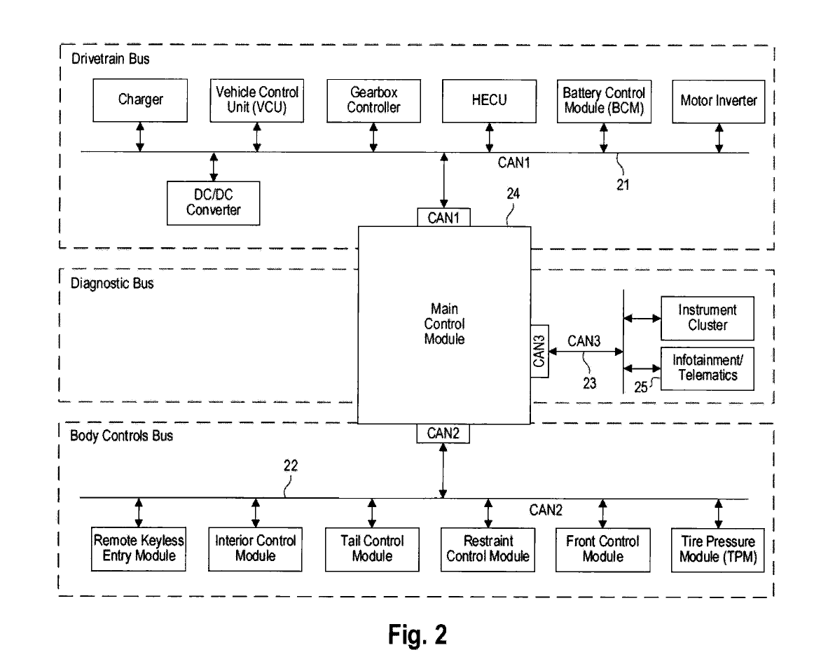

FIG. 2 depicts an exemplary communication network 20 that may be employed by the electric vehicle. In this embodiment, the communication network 20 is comprised of three network buses: a drivetrain bus 21, a body control bus 22 and a diagnostic bus 23. The drivetrain bus 21 interconnects controllers, control units, and other components responsible for generating power and delivering that power to the wheels of the vehicle. The body control bus 22 interconnects controllers and control units related to other vehicle functions, such as door locks, safety restraint, HVAC, etc. A main control module 24 for the vehicle interconnects the computing buses to each other. An infotainment subsystem 25 is in data communication via the diagnostic bus 23 with the main control module 24. Of note, the infotainment system 25 may include the interactive driver subsystem 10 that will increase range confidence for the driver of the electric vehicle.

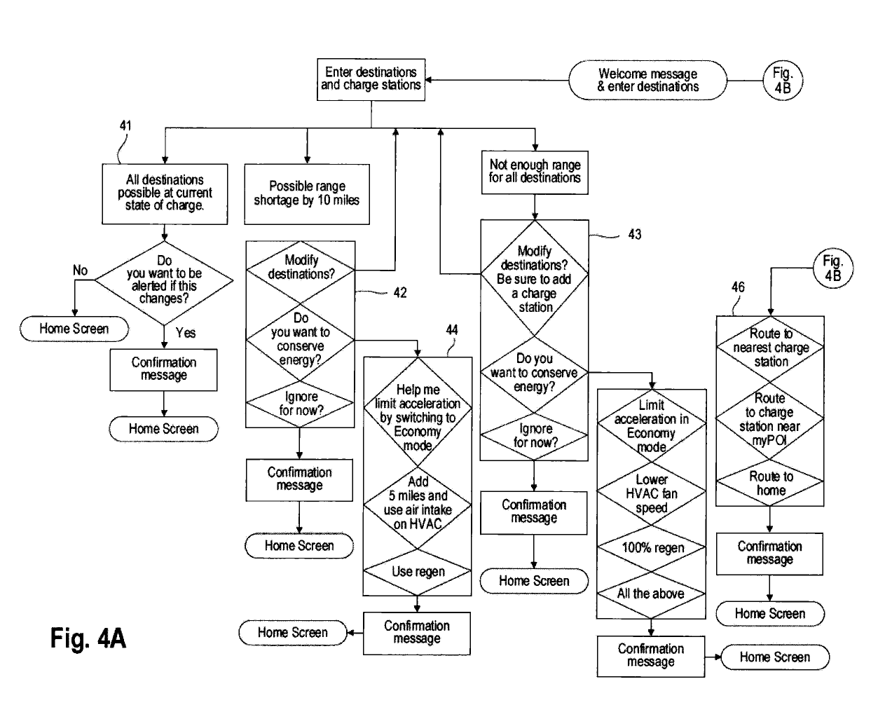

With reference to FIG. 3, the infotainment subsystem 25 is comprised of a conventional computing architecture. The infotainment subsystem 25 includes a central processing unit (CPU) 32 coupled to a data bus 33 as well as random access memory 34, storage memory 35 and other types of data stores coupled to the data bus 33. One or more user interface components 36, such as a display, keyboard or touchscreen, are also coupled to the data bus 33. The computer architecture may further include an input/output (I/O) module (not shown) to facilitate communication with external devices via any suitable means such as wired connection or wireless connection. Other types of computing architectures are also contemplated by this disclosure.

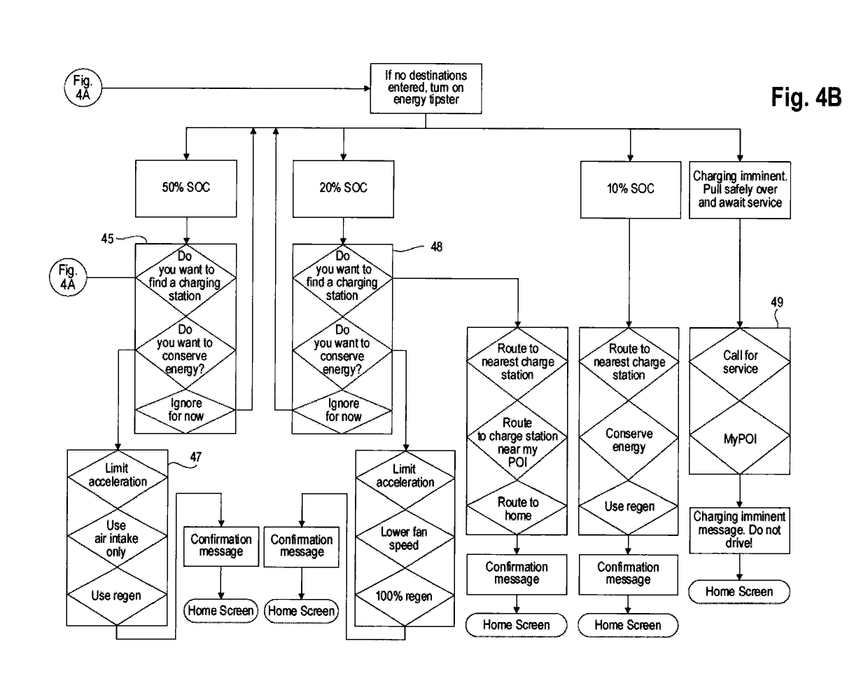

Operation of the interactive driver subsystem 10 that increases range confidence for drivers of an electric vehicle is further described in relation to FIG. 4. During operation of the vehicle, the destination of the vehicle may be known to the interactive driver subsystem. In one embodiment, the interactive driver subsystem 10 may prompt the driver to input a desired destination. The interactive driver subsystem 10 may also interact with a navigation subsystem to acquire a destination previously input by the driver into the navigation subsystem. Alternatively, the interactive driver subsystem 10 may employ machine learning algorithms to determine one or more possible destinations. For example, given the time of day and the route being traveled, a learning algorithm determines that the vehicle is driving toward the driver's home. Other means may be employed to learn the vehicle destination.

Given one or more destinations (or possible destinations), the interactive driver subsystem 10 will monitor the range of the electrical vehicle in relation to each of the destinations. To do so, the subsystem will first determine the current range of the vehicle. In an exemplary embodiment, the predicted range of the vehicle is computed as follows:

$$Predicted Range = \frac{[ \frac{( {Whr}_{inst} - {Whr}_{ign} )}{1 - ( {SOC}_{inst} - {SOC}_{ign} ) )} ]}{( \frac{( {Pwr}_{Batt} )}{Vel} )}$$

where Energyᵢₙₛₜ is an instantaneous determination of energy used from the battery, Energy_{ign} is a determination of energy used from the battery when the vehicle was started, SOCᵢₙₛₜ is an instantaneous determination of state of charge for the battery, SOC_{ign} is a determination of state of charge for the battery when the vehicle was started, Pwrᵢₙₛₜ is an instantaneous measure of power being output by the battery and Vel is the current velocity at which the vehicle is traveling. The predicted range is reported in terms of the distance metric (i.e., mile or meter) used to measure velocity. Each of these parameters is readily available over the vehicle communication bus from either the battery control module or the vehicle control module. While determining the predicted range from the change in energy and change in SOC is preferred, the predicted range could be computed from the instantaneous values for energy and SOC. Change in energy and change in SOC provides normalized energy measurements and accounts for losses inside the battery. It is also noted that determining energy available and state of charge at vehicle start up is an arbitrary point and other points in time could be used to determine the rate of change. Other techniques for computing range also fall within the broader aspects of this disclosure.

Each known destination is then compared to the current range of the vehicle. For example, is the distance to a given destination less than the current range of the vehicle? If so, the destination is deemed to be within the range of the vehicle. When each of the destinations fall within the range of the vehicle, the driver is asked whether they want to be alerted if this condition changes as indicated at 41. In other words, the driver can be alerted when one or more destinations fall outside the range of the vehicle. If the driver elects to be notified, the interactive driver subsystem 10 continues to monitor the range of the electrical vehicle in relation to each of the destinations; otherwise, operation of the interactive driver subsystem is terminated. A confirmation message may be displayed to the driver confirming the driver's election.

When one or more of the destinations fall outside the range of the vehicle, the driver is prompted with a set of actions to be taken. In the exemplary embodiment, the driver is presented with a first set of actions if one or more of the destinations fall barely outside (e.g., 10 miles) the range of the vehicle as indicated at 42 and a second set of actions if one of the destinations falls considerably outside the range of the vehicle as indicated at 43.

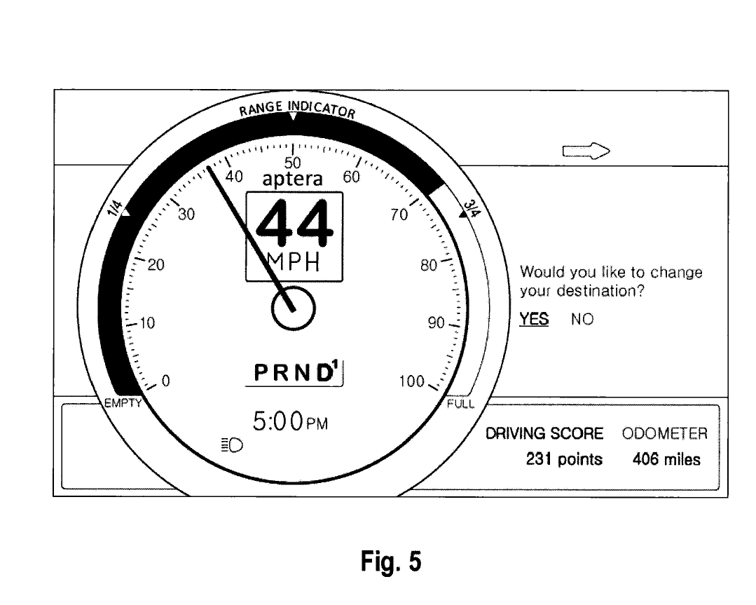

For example, the first set of actions may include modifying the destination, conserving energy and/or ignoring this condition for the time being. FIG. 5 illustrates an exemplary user interface that queries the driver about changing desired destination. By electing to modify the destination, the driver can select a closer destination that falls within the range of the vehicle, thereby ensuring arrival at the newly selected destination. When the destination is remote from the vehicle current location, the driver may elect to ignore this condition for a period of time. Depending on various vehicle parameters and driving conditions, the projected range of the vehicle may change over a longer journey. As the vehicle approaches its destination, a more accurate estimate of vehicle range is available to the driver. In this case, the interactive driver subsystem 10 is configured to redisplay the set of actions to the driver after a predetermined period of time or distance travelled by the vehicle.

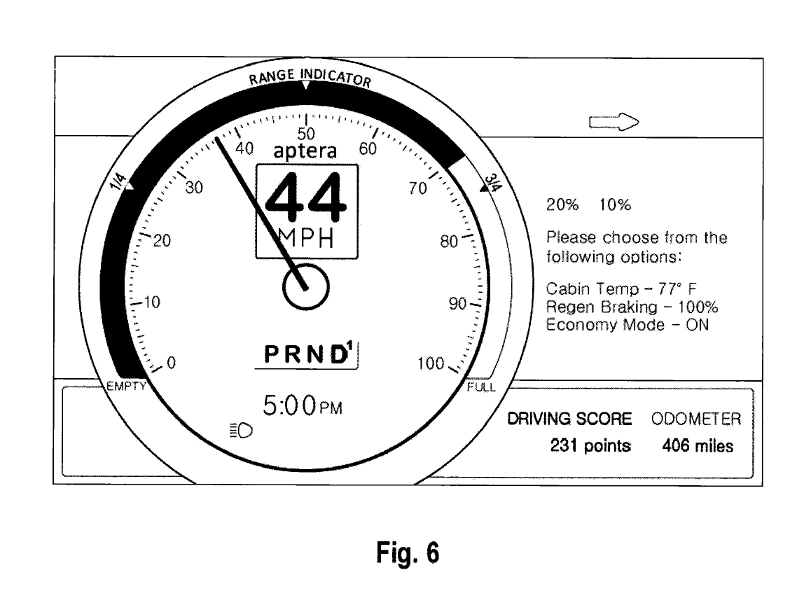

The driver is also given the option of reducing energy consumption in the vehicle. If the driver elects to conserve energy, the driver is presented at 44 with a set of suggestions for reducing the energy consumption. With reference to FIG. 6, suggestions for reducing the energy consumption may include switching to a different drive mode, increasing the level of regenerative braking, driving at a different speed, or modifying a parameter of the HVAC system. In each of these cases, the energy consumption of the vehicle will be reduced if the driver takes the suggested action and a confirmatory message is displayed to the driver. It is readily understood that other means of conserving energy may be presented to the driver in lieu of or in addition to these three options.

For each suggestion, the driver may be presented with an associated change in vehicle range if the suggestion is adopted by the driver. For example, opting to use the air intake function of the HVAC system will increase the vehicle range by five miles. In one embodiment, the amount of change in vehicle range is empirically derived and stored for use during vehicle operation. In another embodiment, the amount of change is computed dynamically by the interactive driver system when presenting the driver with suggestions for reducing energy consumption. This change in vehicle range can be computed by modifying the predictive equation set forth above. The modified equation is as follows:

$$Predicted Range = \frac{[ \frac{( {Whr}_{inst} - {Whr}_{ign} )}{1 - ( {SOC}_{inst} - {SOC}_{ign} ) )} ]}{( \frac{( {Pwr}_{Batt} - {Pwr}_{device} )}{Vel} )}$$

where ΣPwr_{savings} is the sum of calculated power savings for any or all suggested changes. For example, given the power rating of the radio, we can determine how much the power consumption is reduced by subtracting this power rating from the instantaneous measure of power being output by the battery. This leads to an increase in the predicted range of the vehicle. The difference between the range predictions with and without the radio on yield the change in the vehicle range if the driver is to turn off the radio. Different ways of determining the power rating are considered, including measuring the current power usage or using the rating provided by the radio manufactured.

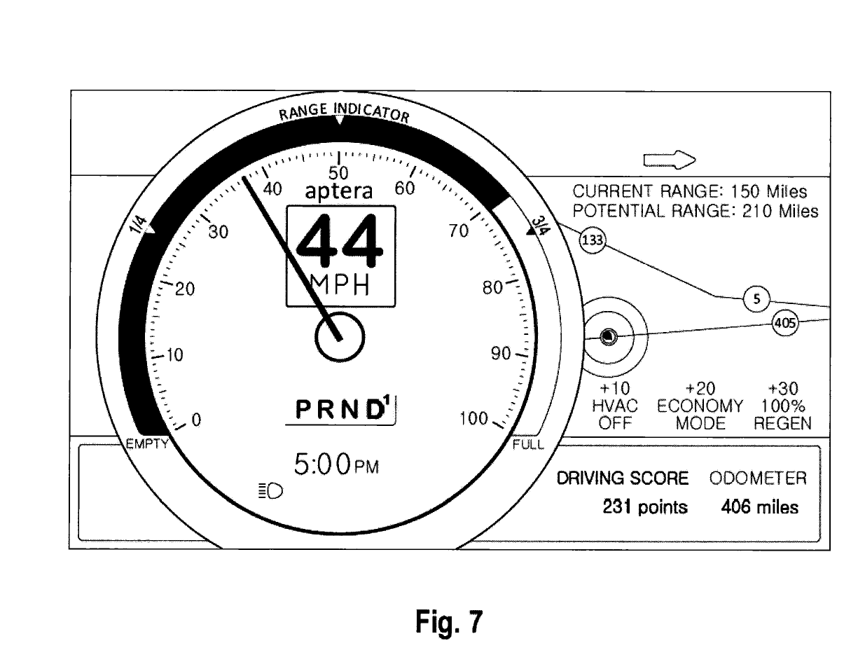

The driver may also be presented with a map showing the current location of the vehicle as shown in FIG. 7. The map may further include indicia for the current range of the vehicle as well as other indicia indicating the associated change in vehicle range if a given suggestion is adopted by the driver. For example, the map may include a boundary (e.g., a circle) specifying the outer range of the vehicle. The map may also include a second or third boundary that specifies the extended range of the vehicle if the driver adopts a corresponding suggestion. For example, the second boundary may extend the range five miles beyond the first boundary if the driver elects to use the air intake function of the HVAC system. A single boundary may also signify the extended range of the vehicle if the driver adopts two of the presented suggestions. Each boundary may be labeled and/or color coded to indicate its significance to the driver.

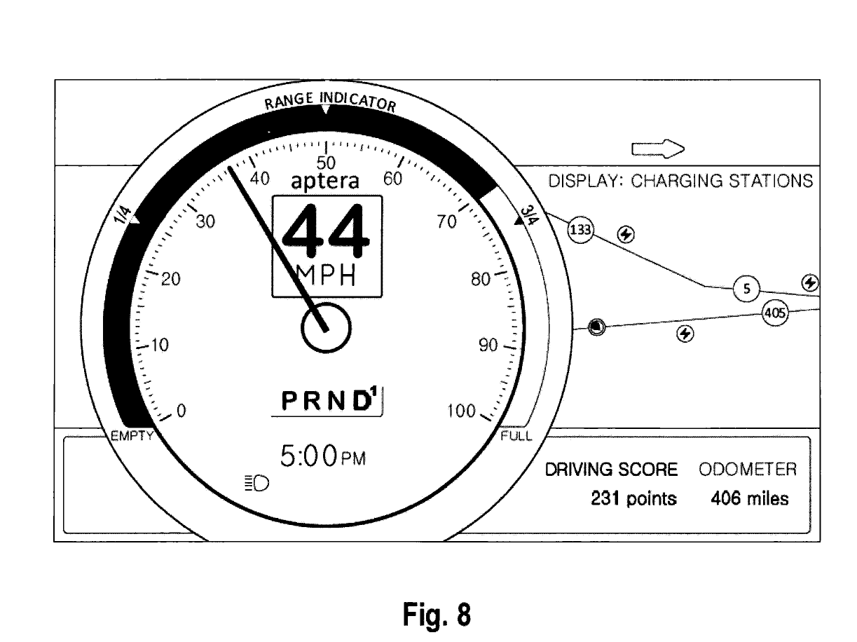

If one of the destinations falls considerably outside the range of the vehicle, the driver is presented with a second set of actions. The second set of actions may be the same as the first set of actions. In other words, the driver may be prompted to modify the destination, conserve energy or ignore this condition for the time being. Alternatively, the second set of actions can include other actions in lieu of or in addition to these actions. For example, the driver may be presented with the option of finding a nearby charging station as shown in FIG. 8. Likewise, if the driver elects to conserve energy, the driver may be presented with the same suggestions for conserving energy as discussed above or a different set of suggestions. For example, the second set of actions may include suggestions that conserve a greater amount of energy. Rather than using the air intake function of the HVAC, the suggestion might be to lower the fan speed which conserves a greater amount of energy but may be less comfortable for the vehicle passengers. The interactive driver subsystem otherwise handles the drivers selection for reducing energy consumption in the manner described above.

Selecting different drive modes enables the driver to conserve energy. In an exemplary embodiment, the electric vehicle is be configured with different drive modes selectable by the driver. The driver may select to drive the vehicle in performance mode, normal mode or economy mode. In performance mode, vehicle parameters are set to achieve maximum performance. For example, a maximum torque value is sent to the electric motor when the acceleration pedal is fully depressed. In this way, the vehicle is accelerated at its maximum achievable amount. However, generating maximum torque may be a less energy efficient condition for vehicle operation. In economy mode, vehicle parameters are set to limit the performance of the vehicle. More specifically, the torque value sent to the electric motor may be limited to 50% of the maximum allowable value. When the acceleration pedal is fully depressed and the maximum torque value in performance mode is 150 at this pedal position, the maximum torque value delivered in economy mode is 75. Likewise, when the acceleration pedal is depressed half way and the maximum torque value in the performance mode is 100 at this pedal position, the maximum torque delivered in economy mode is 50. In normal mode, vehicle parameters are set to achieve some intermediate performance level. For example, the torque value sent to the electric motor may be limited to 75% of the maximum allowable value. By limiting the maximum achievable torque, the driver is able to conserve the amount of energy consumed by the vehicle. Thus, selecting an appropriate drive mode helps to conserve energy and thereby extend the range of the vehicle. It is understood that other types of vehicle operating parameters may be limited in either the normal or economy mode. Further description for how vehicle performance is limited in different modes, reference is made to U.S. patent application Ser. No. ______ <attorney docket no. 33321-000009> entitled “SHIFT CONTROLLER APPARATUS” which is filed concurrently herewith and incorporated herein by reference.

Given a vehicle destination, a change in vehicle range can be estimated for a suggested change in drive mode. Torque at the motor output is proportional to the current through the motor. There is energy transfer inefficiency due to power loss as Joule heating in various components carrying the motor current, such as motor windings, internal battery impedance and electrical cabling. This power loss is proportional to the square of this current. This inefficiency increases in a nonlinear fashion with respect to the torque at the motor. From historical data, the amount of torque needed to reach a particular destination or along a particular route can be estimated. Since the amount of torque is proportional to the current through the motor, the reduction in torque resulting from a change in drive mode can be translated to a power reduction and thus an increase in vehicle range.

Regenerative braking is an energy recovery mechanism which converts kinetic energy to another form. In an electric vehicle, the electric motor is operated as a generator during braking. More specifically, the motor generates torque opposing the rotation of the axles, resulting in vehicle deceleration, converting kinetic energy from the moving vehicle back into electrical energy that may be used to recharge the energy storage system or absorbed by an electrical load. In an exemplary embodiment, the vehicle may be configured to implement different levels of regenerative braking as selected by the driver, where each braking level (e.g., expressed as a percentage) sets a maximum amount of energy output by the electric motor during regenerative braking. Higher the selected regenerative braking level, the more energy is transferred from the motor to recharge the battery system. On the other hand, lower braking levels are less perceptible to the vehicle passengers and thus result in a more comfortable driving experience but less recharging of the battery. When the current regenerative braking level is less than the highest regenerative braking level (i.e., 100%), the interactive driving system 10 may suggest to the driver to increase the regenerative braking level and thereby extend the range of the vehicle. Further description for how to limit the energy output by the motor at different braking levels, reference is made to U.S. patent application Ser. No. ______ <attorney docket no. 33321-000011> entitled “AUTOMOTIVE VEHICLE REGENERATIVE BRAKING CONTROL SYSTEM” which is filed concurrently herewith and incorporated herein by reference.

To predict the amount of change in the vehicle range for different regenerative braking levels, the interactive driver system needs to know the vehicle destination as well as an estimate for the number of regenerative braking events that will occur along the route to the destination. For example, the driver may regularly travel the same route from home to work. From historical data, the interactive driver system can estimate the number of expected regenerative braking events along this route. Given an estimate for the expected regenerative braking events and the suggested regenerative braking level, the driver notification module can compute the increase to the state of charge to the battery. Using the increase in the battery state of charge, the predicted range of the vehicle can be computed using the equation described above. In this way, the change in the vehicle range from modifying the regenerative braking level can be determined and displayed to the driver.

With continued reference to FIG. 4, if no destination is known, then the interactive driver subsystem 10 will monitor the amount of energy available to the vehicle. More specifically, the interactive driver subsystem 10 will monitor the state of charge of the battery system and notify the driver of the vehicle when the state of charge falls below one or more predefined thresholds. In the exemplary embodiment, the interactive driver subsystem 10 determines the current state of charge by polling the battery control module over the vehicle network.

When the state of charge of the battery system is less than a first threshold level (e.g., 50% SoC), the driver is prompted with a set of actions to be taken as indicated at 45. In an exemplary embodiment, the set of actions may include finding a nearby charging station, conserving energy and/or ignoring this condition for the time being. If the driver elects to locate a charging station, the driver is presented with additional options as shown at 46. For example, the driver may chose to find the nearest charging station in relation to his current location, find a charging station(s) along the current route, or provide directions to returning to home (which presumably is a charging station). Upon receipt of the driver's choice, the interactive driver subsystem will present the driver with directions and/or map to one more charging stations meeting the criteria. To generate the directions and/or map, the interactive driver subsystem may include an internal navigation system or interact with an external navigation system.

If the driver elects to conserve energy, the driver is presented at 47 with a set of suggestions for reducing the energy consumption. As discussed above, suggestions for reducing the energy consumption may include switching to a different drive mode, increasing the level of regenerative braking, or modifying a parameter of the HVAC system. In each of these cases, the energy consumption of the vehicle will be reduced if the driver takes the suggested action and a confirmatory message is displayed to the driver.

Since the stored energy continues to be depleted during vehicle operation, the interactive driver subsystem will continue to monitor the state of charge of the battery system. When the state of charge reaches a second lower level (e.g., 20% SoC), the driver is again prompted at 48 with another set of actions to be taken. This second set of actions may be the same as the first set of actions (or may include one or more different actions). Likewise, if the driver elects to conserve energy, the driver may be presented with the same suggestions for conserving energy as discussed above or a different set of suggestions. The driver may be prompted again at one or more predetermined threshold levels in a similar manner. At some nominal state of charge level, the driver is advised to stop operating the vehicle and call for service as indicated at 49.

Furthermore, the interactive driver system controller and software instructions stored in non-transient RAM, ROM or removeable memory therein, can automatically adjust electric load settings based on the suggestions, as agreed to by the driver, to increase efficiency of the vehicle operation and energy usage.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An interactive driver system that alleviates range anxiety for the driver of an electric vehicle, comprising:
a range monitor module that determines range of the electric vehicle and identifies a given condition of the vehicle in which the range of the vehicle may be exceeded during ongoing operation of the vehicle;
a load monitor module that identifies one or more electric loads being placed on a battery of the electric vehicle; and
a driver notification module that presents suggestions on a display of the vehicle to the driver of the vehicle for reducing energy consumption by the vehicle upon occurrence of the given condition, where the suggestions relate to the identified electric loads.

2. The system of claim 1 wherein the driver notification module identifies an action to be taken by the driver that reduces energy consumption and an associated change in the range of the vehicle if the action is taken by the driver.

3. The system of claim 2 wherein the driver notification module displays a map to the driver of the electric vehicle, the map includes an icon placed at current location of the vehicle and indicia for the range of the vehicle in relation to the current location of the vehicle.

4. The method of claim 3 wherein the driver notification module displays another indicia on the map, where the another indicia indicates the associated change in the range of the electrical vehicle if the action is taken by the driver.

5. The system of claim 1 wherein the range monitor module determines range of the vehicle based on a watt-hour metric of the battery, an estimate of current state of charge of the battery, an instantaneous measure of power drawn from the battery and a velocity at which the vehicle is travelling.

6. The system of claim 1 determines a destination for the electric vehicle and notifies the driver of the vehicle when the destination falls outside the range of the vehicle.

7. The system of claim 1 wherein the range monitor module determines current state of charge of the battery and notifies the driver when the state of charge is less than a predefined threshold.

8. The system of claim 1 wherein the driver notification module determines a drive mode currently selected from a plurality of drive modes selectable by the driver, where each drive mode sets a maximum rate of acceleration achievable by the electric vehicle; and suggests that the driver select one of the plurality of drive modes having a maximum rate of acceleration associated therewith that is less than the currently selected drive mode.

9. The system of claim 1 wherein the driver notification module determines a level of regenerative braking currently selected from a plurality of the braking levels selectable by the driver, where each braking level sets a maximum rate of energy recovery recoverable by the regenerative braking mechanism; and suggests that the driver select one of the plurality of braking levels having an associated rate of energy recovery that is greater than the rate of energy recovery that is associated with the currently selected braking level.

10. A method for reducing energy consumption in an electrical vehicle, comprising:
identifying, during operation of an electrical vehicle, a condition of the electric vehicle whereby range of the electrical vehicle may be exceeded;
determining electric loads being placed on a battery system of the electric vehicle during the operation of the electric vehicle; and
presenting a suggestion to the driver for modifying the electric loads currently being placed on the battery system during the operation of the electric vehicle.

11. The method of claim 10 wherein presenting a suggestion to the driver further comprises identifying an action to be taken by the driver that reduces energy consumption by the battery system and an associated change in the range of the electrical vehicle if the action is taken by the driver.

12. The method of claim 10 wherein presenting a suggestion to the driver further comprises identifying two or more actions that reduce energy consumption by the battery system and an associated change in the range of the electrical vehicle for each of the actions, if the corresponding action is taken by the driver.

13. The method of claim 10 wherein identifying a condition of the electric vehicle further comprises determining a destination for the electric vehicle; determining a range for the electric vehicle and notifying the driver of the electric vehicle when the destination falls outside the range of the electric vehicle.

14. The method of claim 10 wherein identifying a condition of the electric vehicle further comprises monitoring state of charge of the battery system and notifying the driver of the electric vehicle when the state of charge of the battery system falls below a predefined threshold.

15. The method of claim 10 further comprises determining a drive mode currently selected from a plurality of drive modes selectable by the driver, where each drive mode sets a maximum rate of acceleration achievable by the electric vehicle; and suggests that the driver select one of the plurality of drive modes having an associated maximum rate of acceleration that is less than the currently selected drive mode.

16. The method of claim 10 further comprises determining a level of regenerative braking currently selected from a plurality of the braking levels selectable by the driver, where each braking level sets a maximum rate of energy recovery recoverable by the regenerative braking mechanism; and suggests that the driver select one of the plurality of braking levels having an associated rate of energy recovery that is greater than the rate of energy recovery that is associated with the currently selected braking level.

17. The method of claim 11 further comprises displaying a map to the driver of the electric vehicle, wherein the map includes an icon placed at current location of the vehicle and indicia for the range of the vehicle in relation to the current location of the vehicle.

18. The method of claim 17 further comprises displaying another indicia on the map, where the another indicia indicates the associated change in the range of the electrical vehicle if the action is taken by the driver.

19. The method of claim 10 further comprising an interactive driver system automatically adjusting electric load settings based on the suggestions, as agreed to by the driver, to increase efficiency of the vehicle.
